(19) United States
(12) Patent Application Publication
(10) Pub. No.: US 2023/0123862 A1
(43) Pub. Date: Apr. 20, 2023

(54) ADAPTIVE PHOTONIC RF SPECTRAL SHAPER

(71) Applicant: University of Georgia Research Foundation, Inc., Athens, GA (US)

(72) Inventors: Mable P. Fok, Bishop, GA (US); Qidi Liu, Athens, GA (US)

(21) Appl. No.: 17/909,574

(22) PCT Filed: Mar. 6, 2021
(86) PCT No.: PCT/US2021/021266

§ 371 Date: Sep. 6, 2022

Related U.S. Application Data
(60) Provisional application No. 62/986,360, filed on Mar. 6, 2020.

(51) Int. Cl. G02F 1/01

(52) U.S. Cl. CPC G02F 1/0123; G02F 1/0115

(57) ABSTRACT

Various examples are provided related to adaptive photonic radio frequency (RF) spectral shapers. In one example, a RF spectral shaper includes processing circuitry that can generate finite impulse response (FIR) parameters based upon a target RF spectral response; an optical wave shaper that can generate a shaped interleaved comb carrier from a broadband optical signal based upon the FIR parameters; an electro-optic modulator (EOM) that can modulate an RF signal onto the shaped interleaved comb carrier to generate a modulated optical comb carrier; and a photodetector that can convert the modulated optical comb carrier back to an RF output signal. In another example, a method includes generating FIR parameters based upon a target RF spectral response; generating a shaped interleaved comb carrier from a broadband optical signal based upon the FIR parameters; and generating a modulated optical comb carrier by modulating an RF signal onto the shaped interleaved comb carrier.

### CROSS REFERENCE TO RELATED APPLICATIONS

This application claims priority to, and the benefit of, co-pending U.S. provisional application entitled “Adaptive Photonic RF Spectral Shaper” having Ser. No. 62/986,360, filed Mar. 6, 2020, which is hereby incorporated by reference in its entirety.

### STATEMENT REGARDING FEDERALLY SPONSORED RESEARCH OR DEVELOPMENT

This invention was made with government support under 1653525 and 1917043 awarded by the National Science Foundation. The Government has certain rights in the invention.

### BACKGROUND

Emerging radio frequency (RF) wireless communication utilizes dynamic usage of the spectrum to fulfill the needs in heterogeneous and multiband communication applications. Due to the ever-increasing operational bandwidth of modern RF systems, the ubiquitousness of high capacity and always-on mobile devices as well as the data-intensive day-to-day applications, there is a need for adaptive RF spectral shaping systems to meet the demands of dynamic multi-function RF systems, so that new applications can be supported and quality of services can be improved. Nevertheless, it is challenging to process and manipulate a wide RF spectrum that spans across tens of GHz bandwidth using either RF electronics or digital signal processing due to the limited wideband functionality of RF electronics as well as the large amount of sampling and computation power needed in digital signal processing. Although electronic-based RF spectral shaping provides an on-chip solution, the tight design criteria and inflexibility in electronics limit the operational bandwidth, the variety of the spectral shaping function, as well as tunability and reconfigurability of the spectral functions that could be achieved.

### SUMMARY

Aspects of the present disclosure are related to adaptive photonic radio frequency (RF) spectral shapers. In one aspect, among others, a radio frequency (RF) spectral shaper, comprises processing circuitry configured to generate finite impulse response (FIR) parameters based upon a target RF spectral response; an optical wave shaper (WS) configured to generate a shaped interleaved comb carrier from a broadband optical signal based upon the FIR parameters; an electro-optic modulator (EOM) configured to modulate an RF signal onto the shaped interleaved comb carrier to generate a modulated optical comb carrier; and a photodetector (PD) configured to convert the modulated optical comb carrier back to an RF output signal.

In one or more aspects, the RF spectral shaper can comprise a dispersion compensating fiber (DCF) disposed between the EOM and the PD to introduce time delay between taps in the modulated optical comb carrier. The processing circuitry can comprise a processor and memory storing a RF spectral decomposition and optimization application executable by the processor. Execution of the RF spectral decomposition and optimization application can cause the processing circuitry to identify a plurality of Gaussian functions based on the target RF spectral response; and determining the FIR parameters based upon characteristics of the plurality of Gaussian functions. The WS can generate interleaved optical comb carriers based upon the FIR parameters. In some aspects, the target RF spectral response supports simultaneous multiband RF communications. The target RF spectral response can support simultaneous S-band, C-band and X-band communications.

In another aspect, a method comprises generating finite impulse response (FIR) parameters based upon a target RF spectral response; generating a shaped interleaved comb carrier from a broadband optical signal based upon the FIR parameters; and generating a modulated optical comb carrier by modulating an RF signal onto the shaped interleaved comb carrier. The method can further comprise converting the delayed and modulated optical comb carrier to an RF output signal. The RF output signal can be produced by a photodetector (PD). The method can further comprise introducing time delay between taps of the modulated optical comb carrier before converting to the RF output signal. The time delay can be implemented using a dispersive device or medium, including dispersion compensation fiber, single mode fiber, or chirped fiber Bragg grating.

In various aspects, the shaped interleaved comb carrier can be produced by an optical wave shaper (WS), or optical filtering devices, or optical frequency comb source. The WS can generate interleaved optical comb carriers based upon the FIR parameters. In some aspects, the method can comprise determining the FIR parameters based upon characteristics of a plurality of Gaussian functions. The method can further comprise identifying the plurality of Gaussian functions based on the target RF spectral response. The FIR parameters can be determined by processing circuitry. The Gaussian functions can be identified by the processing circuity. In one or more aspects, the target RF spectral response can support simultaneous multiband RF communications. The target RF spectral response can support simultaneous S-band, C-band and X-band communications.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates an example of the adaptive photonic RF spectral shaper operation, in accordance with various embodiments of the present disclosure.

FIG. 2 illustrates an experimental setup for evaluation of the adaptive photonic RF spectral shaper, in accordance with various embodiments of the present disclosure.

FIGS. 3A and 3B are plots illustrating an example of the RF spectral decomposition and reconstruction process, in accordance with various embodiments of the present disclosure.

FIG. 3C illustrates an example of simulated amplitude and phase of an optical spectrum for reconstruction of a target RF response, in accordance with various embodiments of the present disclosure.

FIG. 3D illustrates an example of an RF spectral decomposition and optimization algorithm, in accordance with various embodiments of the present disclosure.

FIGS. 4A-4C illustrate examples of simulation results of (a) bandwidth of RF control points vs 3-dB optical bandwidth and length of DCF; (b) step resolution of RF control points vs comb spacing and length of DCF; and (c) step resolution of RF control points vs comb spacing and optical wave shaper step, in accordance with various embodiments of the present disclosure.

FIGS. 5A and 5B are plots illustrating examples of optical spectral processing and target RF responses achieved by the adaptive photonic RF spectral shaper, in accordance with various embodiments of the present disclosure.

FIGS. 6A-6D illustrate examples of experimental results of the adaptive photonic RF spectral shaper using the RF spectral decomposition and optimization algorithm, in accordance with various embodiments of the present disclosure.

FIGS. 7A and 7B illustrate an example of reconstructing a target RF response using over ten spectral control points, in accordance with various embodiments of the present disclosure.

FIGS. 7C and 7D illustrate examples of the step resolution of the adaptive photonic RF spectral shaper at different frequencies, in accordance with various embodiments of the present disclosure.

### DETAILED DESCRIPTION

Disclosed herein are various examples related to adaptive photonic radio frequency (RF) spectral shapers. Microwave photonics offer a good candidate to tackle the challenges of its electronic counterpart due to its merits of large operation bandwidth, high tunability, and high reconfigurability. Spectrally processing RF signal using photonics can be achieved in various ways, including spectral shaping, single and multiband spectral filtering, spectral channelizing, and spectrum analyzing. Successes have been achieved in the field of microwave photonic filtering over the last decade, that provides single passband or multiband filtering with mainly Gaussian profile.

Although passband filtering can be regarded as one type of spectral shaping and is deemed to be the nature way for implementing complex RF spectral shaping; however, it is challenging to achieve RF spectral shaping with good spectral resolution, multiple independent spectral control points, complex shaping functions, and high reconfigurability over tens of GHz frequency range. Several potential candidates for RF spectral shaping include multi-pump Brillouin based microwave photonic filter, FIR based multiband microwave photonic spectral filter, and Kerr comb based RF bandwidth scaling. However, each technique faces critical challenges on implementing RF spectral shaper with complex and adaptive functions. For example, Brillouin technique provides a resolution as high as 32 MHz but lacking spectral profile reconfigurability due to the difficulties in independent gain profile control with multiple Brillouin pumps.

On the other hand, FIR microwave photonic multiband filter offers wideband RF spectral shaping capability, but most existing approaches shows a tight spectral relation between each passband, limiting its independent control capability. Therefore, it is very challenging to achieve dynamic manipulation of wideband RF spectra with independently customizable spectral functions over different frequency channels/bands. Reference will now be made in detail to the description of the embodiments as illustrated in the drawings, wherein like reference numbers indicate like parts throughout the several views.

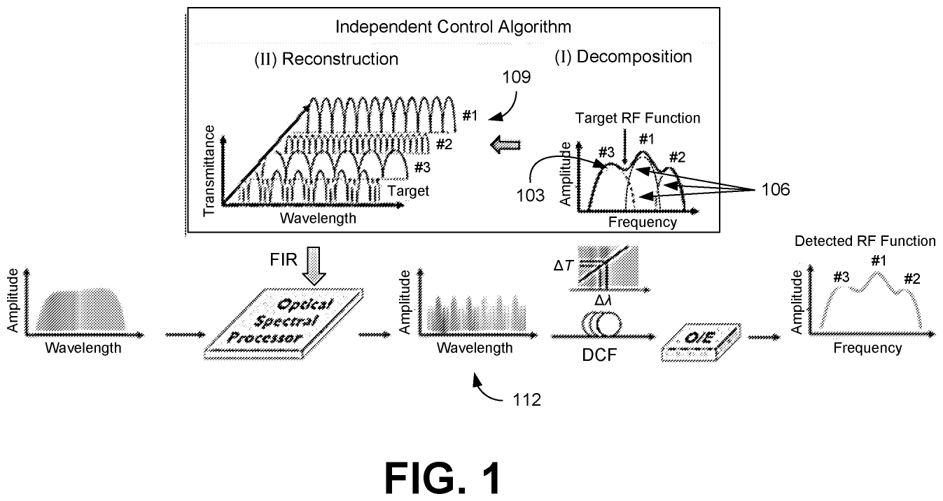

In this disclosure, a novel adaptive microwave photonic RF spectral shaper with multiple adaptive spectral control points over a wideband operational frequency range of about 10 GHz (or higher) is proposed and experimentally demonstrated. FIG. 1 illustrates an example of an adaptive photonic RF spectral shaper with independent control algorithm. The adaptive scheme can automatically break down (or decompose) the target spectral response 103 into a unique series of Gaussian functions 106 according to its spectral characteristic. Then, the corresponding sets of finite impulse response (FIR) parameters are simultaneously generated 109. The FIR parameters are combined and used to control the generation of interleaving optical comb carriers 112 with the correct weight and delay. In this way, the target spectral response 103 can be reconstructed from the optical comb carriers after photodetection.

Unlike an optical to RF spectral mapping approach where the RF resolution is fixed and directly limited by the optical spectral resolution, the adaptive scheme is based on the use of multiple FIR to generate the interleaved optical comb carriers with all the needed free spectral range (FSR) for the reconstruction of the target RF spectral function, significantly improving the step resolution to 10 MHz. Therefore, the disclosed scheme enables adaptive RF spectral shaping with flexible spectral profile through the automatic spectral decomposition and reconstruction processes.

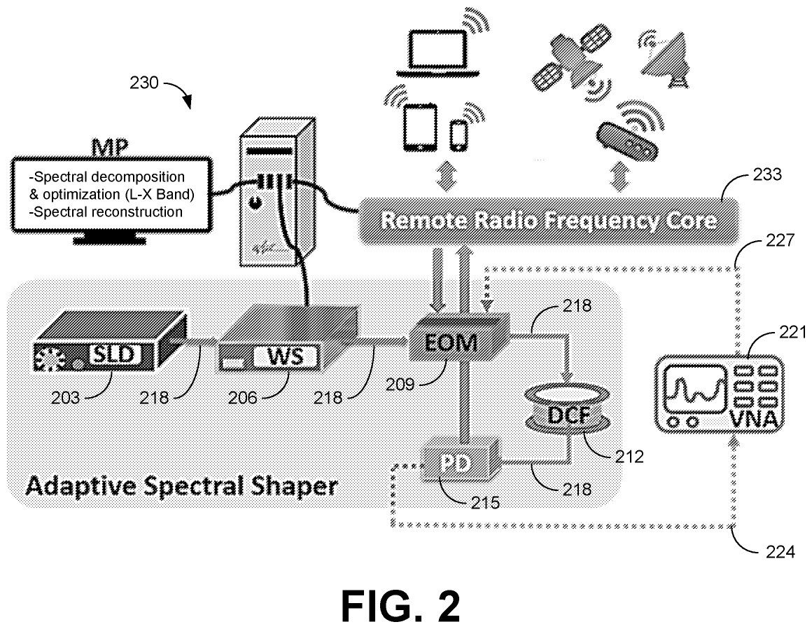

FIG. 2 shows the experimental setup of the proposed adaptive RF spectral shaper. In the example of FIG. 2, the multi-point adaptive RF spectral shaper includes a superluminescent diode (SLD) 203, an optical wave shaper (WS) or optical spectral processor 206, an electro-optic modulator (EOM) 209, a dispersion compensating fiber (DCF) or dispersive medium 212, and a photodetector (PD) 215 coupled through an optical path 218. A vector network analyzer (VNA) 221 is shown receiving an electrical output signal 224 from the PD 215 and/or providing an electrical input signal 227 to the EOM 209 for measuring the frequency response. A microprocessor (MP) 230 in, e.g., a computing device or processing circuitry can be configured to execute a RF spectral decomposition algorithm (e.g., stored in memory).

The SLD 203 (e.g., Thorlabs SLD S5FC1005S) can be used as a broadband optical source, which covers a wavelength range of, e.g., from 1528 nm to 1568 nm. The WS 206 (Finisar 1000S) can be used for controlling the optical spectral properties of the broadband optical source through spectral slicing, such that interleaved combs with the designed amplitude, bandwidth, spacing, and envelope profile can be generated all at once based on the results from the RF spectral decomposition algorithm. Since the optical comb generation and shaping are performed at the same time at the WS 206, no complex spectral alignment or calibration is needed. The EOM 209 (e.g., a 12-GHz electro-optic modulator such as a Fujitsu FTM7921ER) can be used to modulate the RF signal from the remote RF core 233 onto the shaped comb carrier.

In the experiments, a sweeping RF signal from a 20-GHz VNA 221 (e.g., Agilent E5071C) was used as the RF input 227 for characterization of the adaptive RF spectral shaper. The FIR tap delay can be provided by the DCF 212 with a total dispersion of, e.g., 425 ps/nm. The PD 215 18-GHz photodetector can be used to convert the modulated and delayed optical comb carrier back to the RF domain and the resultant RF response 224 can be measured by the VNA 221. The enabler of the adaptive and independent multi-point control of the RF spectral response is the two-section algorithm for optimized spectral decomposition and spectral reconstruction of the target RF response.

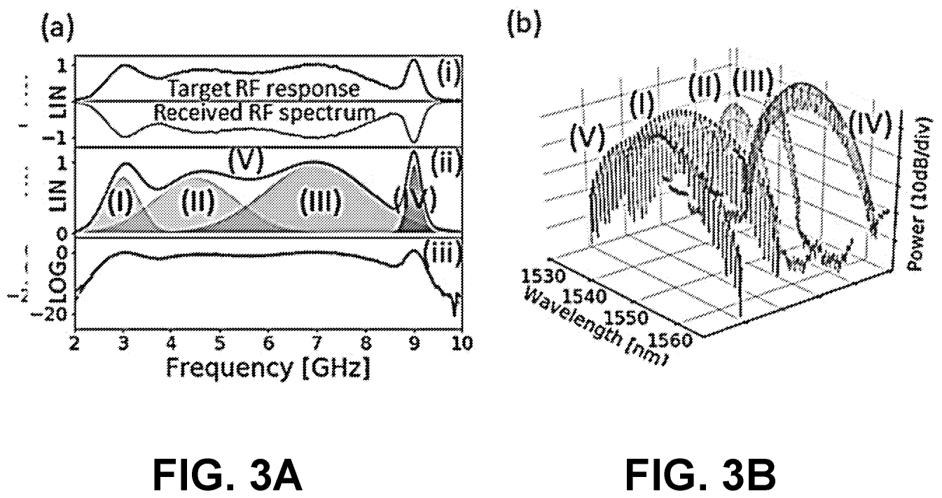

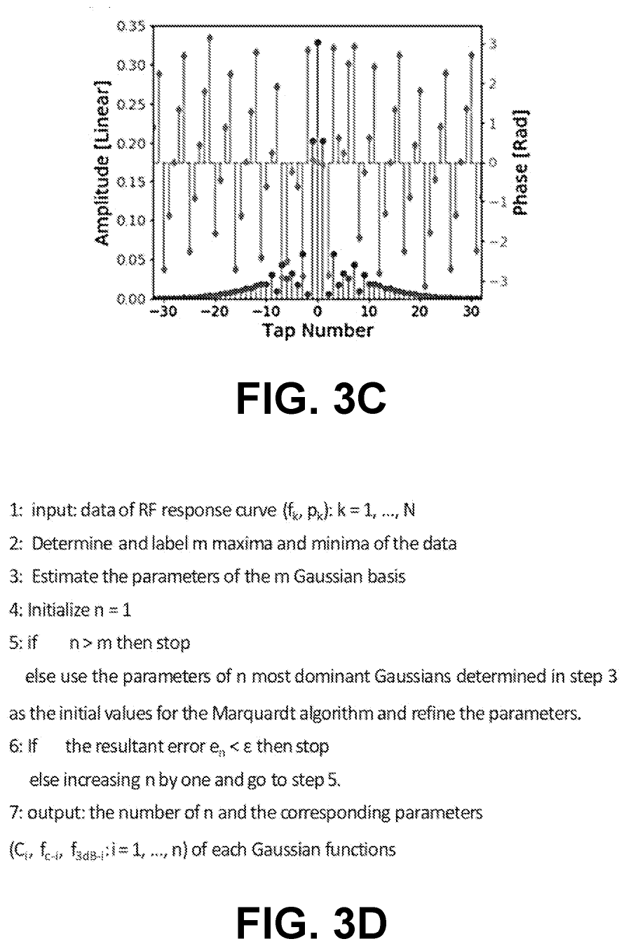

RF Spectral Decomposition and Optimization. Based on radial basis decomposition, the wideband RF spectrum can be represented by orthogonal basis in the form of a series of Gaussian functions, with different bandwidths and amplitudes; similar to how a repetitive time domain waveform can be decomposed into a series of sinusoid basis at different frequency. FIGS. 3A and 3B illustrates an example of the optimized RF spectral decomposition and reconstruction process. The top section (i) illustrates an example of the received RF spectrum 303 and the target RF response in linear scale 306, the middle section (ii) illustrates the optimized and decomposed spectra (I-IV) in the form of Gaussian functions and the summation of the Gaussian functions (V), which are in linear scale, and the bottom section (iii) illustrates the reconstructed RF spectra and the target RF response, which are substantially aligned, in log scale.

Given the target RF spectral response 306 (e.g., a complementary RF response of the received RF response 303 for equalization), the target spectrum or spectral response can be decomposed into a series of Gaussian functions (I-IV), as shown in the middle section (ii) of FIG. 3A. The decomposition process can be achieved by having Gaussian peaks aligning at the maxima of the RF response 306, while the overlapping of the tails of Gaussian functions (I-IV) forms the minima or plateaus. Therefore, a widely spaced subset of Gaussian functions with wide bandwidth can lead to a gentle change in the resultant RF spectral response with coarse spectral control, while fine control of sharp amplitude changes in the RF response can be achieved by offset-overlapping a narrow bandwidth Gaussian function with a main wideband Gaussian function. FIG. 3B shows the corresponding optical spectral control with independent comb properties (I, II, III and IV) and corresponding aggregated optical spectrum (V).

Overlapping regions between each Gaussian function could constitute a valley or plateau in the RF response. Therefore, the number of Gaussian functions can correspond to the number of control points needed in the RF spectral reconstruction and the Gaussian functions do not have to be equally spaced. On the other hand, if the direct FIR approach is used, complex and fast phase varying optical spectrum is needed to reconstruct the target spectrum. FIG. 3C shows an example of the simulated amplitude and phase requirement of the optical spectrum for the reconstruction of the target RF response in FIG. 3A using direct FIR approach, which is extremely difficult to achieve. The goal of the RF spectral decomposition and optimization algorithm of FIG. 3D is to identify and optimize the Gaussian functions with different amplitude and bandwidth properties needed in the target RF spectral response, including the total number of Gaussian functions n for RF spectral reconstruction and the detail parameters of the i^{th} Gaussian function, such as amplitude Cᵢ, center frequency f_{c-i}, and 3-dB bandwidth f_{3dB-i}.

The mathematical expression of the decomposed group of Gaussian functions can be expressed as:

$${F}_{R} ( f ) = {\sum }_{i = 1}^{n} {C}_{i} exp [ - \frac{{( f - {f}_{c - i} )}^{2}}{2 {f}_{3 dB - i}^{2}} ] . \qquad ( 1 )$$

Although the discrepancy between the target RF response and the reconstructed RF response could be reduced using a large number of Gaussian functions, an overly large number of Gaussian functions will consequently degrade the optical comb carrier quality (i.e. the comb features could be masked by another comb) and negatively affect the RF response reconstruction performance. Therefore, the algorithm of FIG. 3D aims to identify the optimized number (n) of Gaussian functions needed for RF response reconstruction while keeping the discrepancy within the tolerable error limit, ε, governed by:

$$\sqrt{\frac{1}{N} {\sum }_{k = 1}^{N} {( {F}_{R} ( {f}_{k} ) - {P}_{k} )}^{2}} < ε , \qquad ( 2 )$$

where N is the total number of frequency points for describing the target RF spectral response, pₖ is the power magnitude of the k^{th} frequency point, and F_{R}(fₖ) is the fitted power function of the k^{th} power that contributes to maintaining the RF response discrepancy within ε. Note that the Marquardt algorithm is used to find the local minimum of the cost function, and the initial parameter is estimated by the maximums and minimums of the target RF response to ensure the algorithm of FIG. 3D converges.

RF Spectral Reconstruction. Once the RF spectral decomposition algorithm has determined all the feature parameters for the set of Gaussian functions, second part of the algorithm determines the corresponding parameters for generating the optical comb carrier that forms the Gaussian functions for the reconstruction of the target RF spectrum, including the comb amplitude Aₙ, the 3-dB optical envelope bandwidth Δω_{3 dB-n}, and the comb FSR Δω_{FSR-n} of the n-th group of optical comb. The comb FSR and the 3-dB bandwidth are determined by,

$$Δ {ω}_{F S R - n} = \frac{2 π}{{β}_{2} {L}_{D C F} {f}_{c - n}} , Δ {ω}_{3 d B - n} = \frac{\sqrt{8 ln 2}}{{β}_{2} {L}_{DCF} Δ {f}_{3 dB - n}} , \qquad ( 3 )$$

where β₂ and L_{DCF} represent group velocity dispersion and length of the DCF, respectively, with center frequency f_{c-n} and 3-dB bandwidth f_{3dB-n}.

Since all the optical parameters are combined before using it to control the optical comb generation process, the whole set of optical combs are interleaved and sliced all at once using one spectral shaper. Furthermore, the Gaussian functions in the RF domain F_{R}(f) and the corresponding envelope of the optical comb carrier Hₙ(ω) has a Fourier transform relationship. Therefore, the final aggregated optical comb carrier T(ω) can be expressed as a summation of cosine functions with Gaussian envelope Hₙ(ω) as:

$$T ( ω ) = {\sum }_{n = 1}^{N} {A}_{n} cos ( \frac{{Δω}_{n}}{{Δω}_{FSR - n}} \frac{ω}{2} ) {H}_{n} ( ω ) , \qquad ( 4 )$$

where Δωₙ denotes the full optical bandwidth of each Gaussian-shaped optical comb carrier. FIG. 3B shows the measured optical spectra of the four sets of Gaussian-shaped optical comb that corresponds to the four Gaussian RF functions (I, II, III, and IV curves), as well as the final aggregated optical comb carrier (V curve) that corresponds to the resultant RF response. The final optical comb carrier keeps all the features of the subset group of optical combs.

According to Eq. (3), the minimum bandwidth of each RF control point (i.e. RF feature) can be determined by the 3-dB bandwidth of the overall optical comb and the total dispersion provided. While the maximum bandwidth of each RF control point is limited by how narrow the overall optical comb bandwidth could be as well as the photodetector bandwidth. Suppose the dispersion constant β₂ is unchanged, the resultant bandwidth range of each RF control point can be from several tens of MHz to a few GHz.

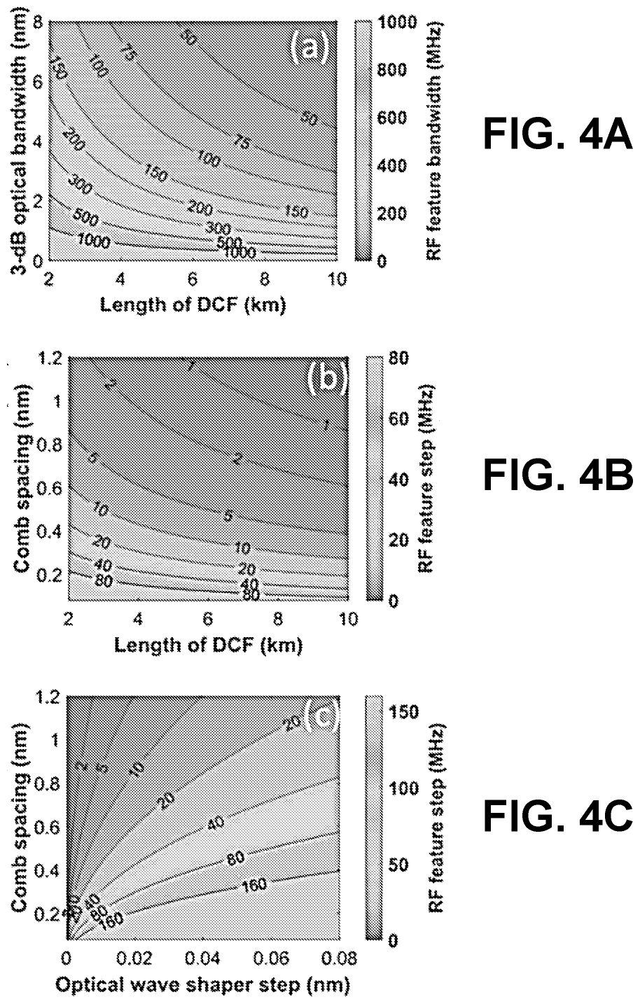

FIG. 4A illustrates an example of simulation results of bandwidth of each RF control point (RF feature) vs 3-dB optical bandwidth and length of DCF, with fixed dispersion constant. FIG. 4B illustrates an example of simulation results of step resolution of each RF control point vs comb spacing and length of DCF, with fixed optical wave shaper step (addressability). FIG. 4C illustrates an example of simulation results of step resolution of each RF control point vs comb spacing and optical wave shaper step, with fixed dispersion constant.

In addition, the RF step resolution Δfₛₜₑₚ (how close two RF control points can be placed) is simulated and is shown in FIG. 4B. It is observed that the larger the optical comb spacing, the finer the RF step resolution would be. The addressability of the optical wave shaper also plays a role in governing the RF step resolution, as shown in FIG. 4C. The optical step resolution in the optical wave shaper (WS 206 of FIG. 2) governs the precision of the optical comb FSR, which in turn determines the step resolution of the RF response. The mathematical relationship can be expressed as,

$$Δ {f}_{step} = \frac{{Δω}_{add}}{2 {πβ}_{2} {L}_{DCF} {Δω}_{FSR} ( {Δω}_{FSR} + {Δω}_{add} )} , \qquad ( 5 )$$

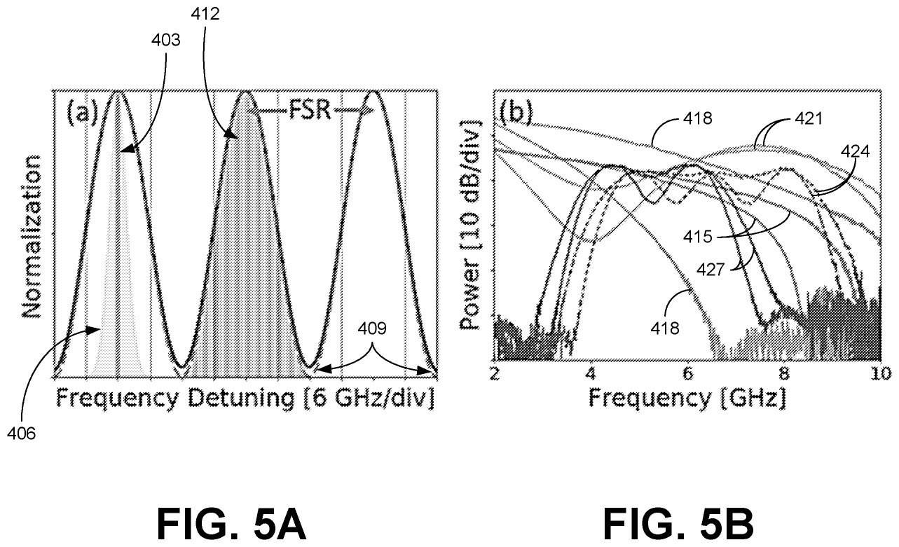

In the experimental testing, the WS 206 (FIG. 2) used for generating the optical comb carriers had a 12-GHz spectral resolution, and an addressability of 1 GHz. FIG. 5A illustrates an example of the optical spectral processing for multiple control points and the step resolution. FIG. 5B shows samples of target RF responses achieved by the RF spectral shaper that are commonly needed in RF systems. The user can control the amplitude of each 1 GHz points 403, but the actual response has a 12 GHz full bandwidth 406. For example, if a periodic cosine function is used to mimic optical combs, as shown by dashed line 409 in FIG. 5A, the amplitude at each 1 GHz spacing 412 is set to the desired value.

In this way, the normalized target optical comb can be represented by Gaussian shape functions due to the 12-GHz spectral resolution of the WS 206, but all the feature parameters are maintained. The 1 GHz step resolution Δω_{add} governs the precision of FSR in optical domain, which further determines the step resolution in RF domain Δf=f_{c}²Δω_{add}β₂L_{DCF}. Thus, the resultant RF response step resolution is 18.3 MHz at 6 GHz when the comb FSR is changed by 1 GHz.

A preliminary experiment was performed to verify the ability of the RF spectral shaper to generate different RF spectral shaping/equalization functions across a 10 GHz bandwidth. FIG. 5B shows several examples of commonly needed target RF spectral responses in RF systems including a negative linear response with variable slopes (415 and 418), sinusoid (421), and bandpass-shaping (424 and 427). The generated RF responses show dynamic, precise, and continuous spectral tailoring capability of the adaptive RF spectral shaper. The orthogonal Gaussian basis used in the adaptive algorithm is to provide a general yet dynamic decomposition solution for complex wideband RF response. In the experiment, the narrowest bandwidth obtained by the RF Gaussian function was 180 MHz, while the widest bandwidth was expected to be 55 GHz if the modulator and the photodetector could support it.

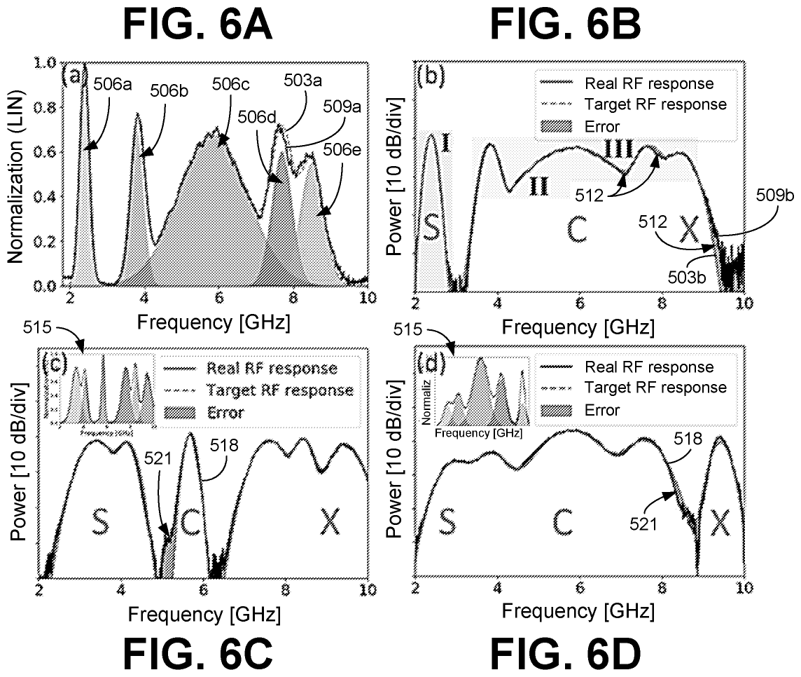

Next, the feasibility of simultaneous multiband (S, C, and X bands) spectral shaping with non-uniform and fully customizable spectral properties was demonstrated, with the results shown in FIGS. 6A-6D. First, the target RF response is defined by the user as indicated by the dashed curve 503a (in linear scale) in FIG. 6A. The target function in log scale is shown by the dashed curve 503b in FIG. 6B. In this example, the frequency response was designed to support simultaneous Bluetooth®/WiFi transmission (S band) as well as gain equalization at higher frequency ranges (C+X bands). The adaptive algorithm automatically decomposed the target RF response 503 into an optimized number of Gaussian functions (indicated by the five shaded areas (506a-506e) centered at 2.4 GHz, 3.8 GHz, 5.8 GHz, 7.8 GHz and 8.5 GHz) for obtaining the desired RF response. Then, the algorithm generates the corresponding optical parameters for the optical comb carriers according to Eqs. (3) and (4). The parameters can be used to control the programmable optical processer (FIG. 1) to implement the WS 206 (FIG. 2) for generating the optical comb carriers used for the reconstruction of the target RF response 503.

After photodetection, the reconstructed RF response is shown by the linear scale curve 509a in FIG. 6A and the log scale curve 509b in FIG. 6B. It is observed that the Bluetooth®/WiFi transmission window at 2.4 GHz (region I of FIG. 6B) has a 40-dB rejection ratio, while gain compensation in Regions II and III (FIG. 6B) have a 10 dB and 6 dB dynamic shaping range, respectively. The discrepancy between the target and resultant RF responses is marked by the shaded regions 512 that indicates a small error of <1%. Furthermore, different target RF responses were presented to the RF spectral shaper to verify its adaptability and reconfigurability.

As shown in FIG. 6C, the target RF response facilitates transmission in the C band and dynamic gain compensation in the S+X bands, while FIG. 6D shows the target RF response that can utilize dynamic spectral equalization in S+C bands and signal transmission in X band. The decomposed Gaussian functions are depicted by the shaded areas in the linear scale insets 515. The resultant RF responses generated by the RF spectral shaper are shown by the solid curve 518, while the discrepancies are indicated by the shaded areas 521 in FIGS. 6C and 6D. The results show that the proposed RF spectral shaper successfully adapted to changes in the user defined target RF response and generated the corresponding RF response with small discrepancy.

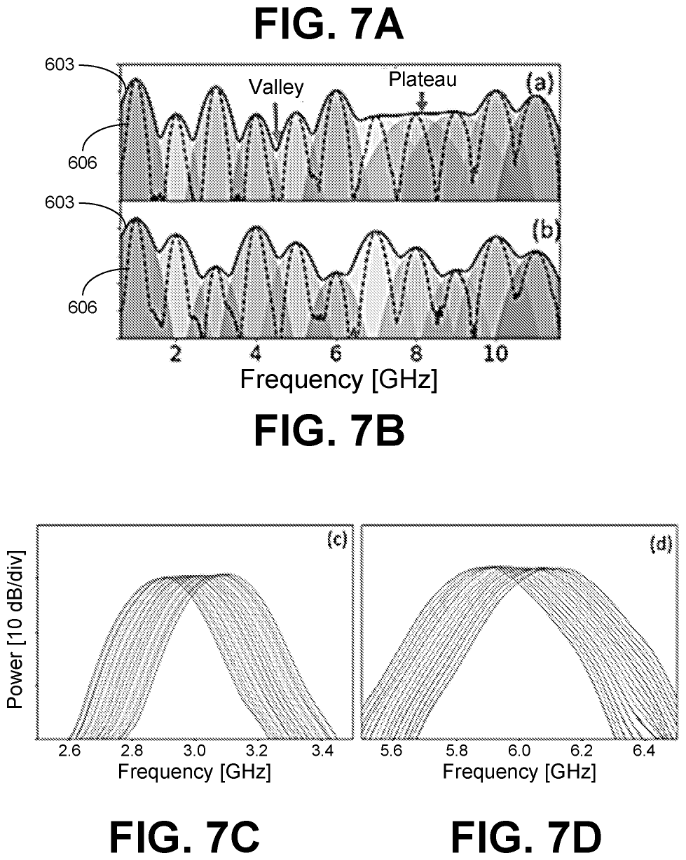

As the number of spectral control point increases, some of the comb features could be masked by another comb, resulting in ripples in the resultant RF response. The maximum number of control point (number of Gaussian functions for reconstruction) supported by the RF spectral shaper without degrading the resultant RF response was examined. FIGS. 7A and 7B illustrate eleven spectral control points reconstructing a target RF response with randomly and periodical amplitudes. FIGS. 7C and 7D show step resolution demonstrations centered around 3 GHz and 6 GHz, respectively.

First, each Gaussian function was intentionally set to have a narrow 3-dB bandwidth of 180 MHz with shaping slope of 0.03 dB/MHz and were evenly spaced at 1 GHz, as shown by the dashed lines 606 in FIGS. 7A and 7B, so that each of the Gaussian peaks can be clearly seen without overlapping. Bandwidth of RF control points are governed by the total dispersion, a 90 MHz bandwidth can be achieved when a 5 km DCF is used. The RF spectral shaper successfully supported 11 spectral control points with varying resolutions. The control points can be placed as close as tens of MHz with an uneven spacing if desired, which is governed by the addressability of the WS 206 (FIG. 2) and the dispersion of DCF 212 (FIG. 2). As the bandwidth of the Gaussian functions increase, as illustrated by the shaded Gaussian shapes, tails of the Gaussian functions overlap and form the valleys and plateaus of the RF response, as shown by the solid curves 603. FIGS. 7C and 7D illustrates the fine tuning of the center frequency position of the target function peak, which indicates that the 1 GHz addressability in the WS 206 resulted in a step resolution of 7.8 MHz and 18.3 MHz in center frequency at 3 GHz and 6 GHz in both directions, respectively.

RF spectral shapers are a component that is readily utilized in emerging multi-service mobile communications, multiband satellite and radar systems as well as future 5G/6G radio frequency systems, for equalizing spectral unevenness, removing out-of-band noise and interference, as well as manipulating multi-band signal simultaneously. While it is easy to achieve simple spectral functions using either conventional microwave photonic filters or optical spectrum to microwave spectra mapping techniques, it is challenging to enable complex spectral shaping functions over tens of GHz bandwidth as well as achieving point-by-point shaping capability to fulfill the needs in dynamic wireless communications. In this disclosure, a novel spectral shaping system was presented, which utilizes a two-section algorithm to automatically decompose a target RF function into a series of Gaussian functions and reconstruct the desired RF function by microwave photonic techniques. The devised spectral shaping system can manipulate the spectral function in various bands (S, C, and X) simultaneously with a step resolution of as fine as tens of MHz. The resolution limitation in optical spectral processing can be mitigated using a discrete convolution technique.

The adaptive and customizable multi-point RF spectral shaper with tens of MHz step resolution was experimentally demonstrated. Over ten spectral control points were experimentally achieved based on the adaptive RF spectral shaper. The two-section algorithm decomposed and optimized the target RF response into a series of Gaussian functions and generated the corresponding parameters for the construction of optical comb carriers that were used for the reconstruction of the target RF response. Simultaneous dynamic spectral shaping with a user-defined shaping function in S, C and X bands was successfully achieved. Furthermore, the adaptive RF spectral shaper mitigated the optical coarse resolution presented in most optical to RF spectrum mapping schemes. The adaptive RF spectral shaper offers a potential solution to software defined radio (SDR) systems due to its fully programmable capability and the automatic adaptive RF spectral decomposition and reconstruction processes.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

1. A radio frequency (RF) spectral shaper, comprising:
processing circuitry configured to generate finite impulse response (FIR) parameters based upon a target RF spectral response;
an optical wave shaper (WS) configured to generate a shaped interleaved comb carrier from a broadband optical signal based upon the FIR parameters;
an electro-optic modulator (EOM) configured to modulate an RF signal onto the shaped interleaved comb carrier to generate a modulated optical comb carrier; and
a photodetector (PD) configured to convert the modulated optical comb carrier back to an RF output signal.

2. The RF spectral shaper of claim 1, comprising a dispersion compensating fiber (DCF) disposed between the EOM and the PD to introduce time delay between taps in the modulated optical comb carrier.

3. The RF spectral shaper of claim 1, wherein the processing circuitry comprises a processor and memory storing a RF spectral decomposition and optimization application executable by the processor.

4. The RF spectral shaper of claim 3, wherein execution of the RF spectral decomposition and optimization application causes the processing circuitry to:
identify a plurality of Gaussian functions based on the target RF spectral response; and
determining the FIR parameters based upon characteristics of the plurality of Gaussian functions.

5. The RF spectral shaper of claim 4, wherein the WS generates interleaved optical comb carriers based upon the FIR parameters.

6. The RF spectral shaper of claim 1, wherein the target RF spectral response supports simultaneous multiband RF communications.

7. The RF spectral shaper of claim 6, wherein the target RF spectral response supports simultaneous S-band, C-band and X-band communications.

8. A method, comprising:
generating finite impulse response (FIR) parameters based upon a target RF spectral response;
generating a shaped interleaved comb carrier from a broadband optical signal based upon the FIR parameters; and
generating a modulated optical comb carrier by modulating an RF signal onto the shaped interleaved comb carrier.

9. The method of claim 8, further comprising converting the modulated optical comb carrier to an RF output signal.

10. The method of claim 9, wherein the RF output signal is produced by a photodetector (PD).

11. The method of claim 9, further comprising introducing time delay between taps of the modulated optical comb carrier before converting to the RF output signal.

12. The method of claim 11, wherein the time delay is provided via a dispersion compensating fiber.

13. The method of claim 8, wherein the shaped interleaved comb carrier is produced by an optical wave shaper (WS).

14. The method of claim 13, wherein the WS generates interleaved optical comb carriers based upon the FIR parameters.

15. The method of claim 8, comprising determining the FIR parameters based upon characteristics of a plurality of Gaussian functions.

16. The method of claim 15, further comprising identifying the plurality of Gaussian functions based on the target RF spectral response.

17. The method of claim 15, wherein the FIR parameters are determined by processing circuitry.

18. The method of 8, wherein the target RF spectral response supports simultaneous multiband RF communications.

19. The method of claim 8, wherein the target RF spectral response supports simultaneous S-band, C-band and X-band communications.
